(19) United States
(12) Patent Application Publication
(10) Pub. No.: US 2008/0006044 A1
(43) Pub. Date: Jan. 10, 2008

(54) Method for controlling temperature

(76) Inventor: Ziming Tan, Basking Ridge, NJ (US)

Correspondence Address: Edwards Vacuum, Inc., 55 MADISON AVENUE, Suite 400, MORRISTOWN, NJ, 07960, US

(21) Appl. No.: 11/825,340

(22) Filed: Jul. 3, 2007

Related U.S. Application Data
(60) Provisional application No. 60/819,760, filed on Jul. 10, 2006.

(51) Int. Cl. F25B 49/00; G05B 13/00

(52) U.S. Cl. 62/197; 700/45

(57) ABSTRACT

A method for controlling the temperature of a coolant supplied to a process, such as a semiconductor process. The method provides for chilling a coolant to a predetermined temperature, controlling the coolant at the predetermined temperature and delivering the coolant to the semiconductor process. The method includes feedback and feed-forward control algorithms to control the temperature to within about ±0.1° C. under steady state conditions and to within about ±0.75° C. under maximum heat loading and unloading conditions. The invention may be used in any fluid or component temperature control application (e.g. semiconductor, pharmaceutical, or food applications).

### FIELD OF THE INVENTION

The present invention relates to a method for controlling the temperature of a coolant supplied to a process. More specifically, the present invention provides a method for chilling a coolant to a predetermined temperature, controlling the coolant at the predetermined temperature and delivering the coolant to a semiconductor process.

### BACKGROUND OF THE INVENTION

Chillers are used in a number of industries to control the temperature of process fluids and components. For example, in the semiconductor industry, a typical wafer processing step involves a series of heat loading and unloading segments, and chillers are used to control the temperature of electrostatic chucks, quartz windows and chamber walls.

Known chillers for controlling the temperature of a coolant supplied to a semiconductor process are the BOC Edwards, Inc. TCU 40/80 and TCU 40/80+. The TCU 40/80 chillers utilize feedback control to maintain the temperature of a coolant supplied to a semiconductor process tool at a predetermined setpoint. The TCU 40/80 chillers include a coolant loop for removing heat from the process tool, a refrigerant loop for removing heat from the coolant loop and a cooling water loop for removing heat from the refrigerant loop. The TCU 40/80 chillers operate using a standard feedback method by measuring the temperature of the coolant supplied to the process tool, comparing the difference between the measured coolant temperature and the predetermined setpoint and sending a signal to an expansion valve in the refrigerant loop to adjust the flow rate of the refrigerant.

While the TCU 40/80 and TCU 40/80+ chillers can control the coolant temperature to about ±1° C. under steady-state conditions and about ±1.5° C. under maximum heat loading or unloading, these chillers have problems with noticeable temperature overshoot, temperature oscillation, gradual deterioration in performance or even to loss of control particularly during times of dynamic heat loading and unloading by the process. Thus, there is a need for an improved method for controlling the temperature of a coolant supplied to a process and for quickly responding to dynamic heat loading and unloading (heat change) resulting from the process.

### SUMMARY OF THE INVENTION

A method for controlling temperature of a process comprising the steps of: supplying a coolant from an evaporator to the process; measuring temperature of the coolant supplied to the process; determining the difference between the coolant supply temperature and a coolant supply temperature setpoint; removing heat from the coolant by flowing a refrigerant through the evaporator; measuring temperature of the coolant returning from the process; calculating a differential exponentially weighted moving averaged (DEWMA) from the measured coolant supply temperature and the measured coolant return temperature; determining a heat change state by comparing the DEWMA to predetermined logic rules; predicting the temperature of the coolant returning from the process based upon the heat change state; and adjusting flow rate of the refrigerant based upon the predicted temperature.

### BRIEF DESCRIPTION OF THE DRAWINGS

FIG. 1 is a schematic representation of the apparatus according to the present invention.

FIG. 2 is an illustration of a heat loading and unloading process.

FIG. 3 is an illustration of exponentially weighted moving averages as compared to a measure source signal.

FIG. 4 is an illustration of a differential exponentially weighted moving average as a function of probability using linear interpolation.

FIG. 5 is an illustration of a differential exponentially weighted moving average as a function of probability using non-linear interpolation.

FIG. 6 is experimental data illustrating the performance of the present invention.

### DETAILED DESCRIPTION OF THE INVENTION

The present invention provides a method for controlling the temperature of a process. More specifically, the invention provides a method for controlling the temperature of a fluid or a component operating within a process. The method includes feedback and feed-forward control algorithms to control the temperature to within about ±0.1° C. under steady state conditions and to within about ±0.75° C. under maximum heat loading and unloading conditions. While the invention may be used in virtually any kind of fluid or component temperature control application (e.g. semiconductor, pharmaceutical, or food applications), the invention will be described herein as it is applies to controlling the coolant temperature of a semiconductor process component during semiconductor manufacturing.

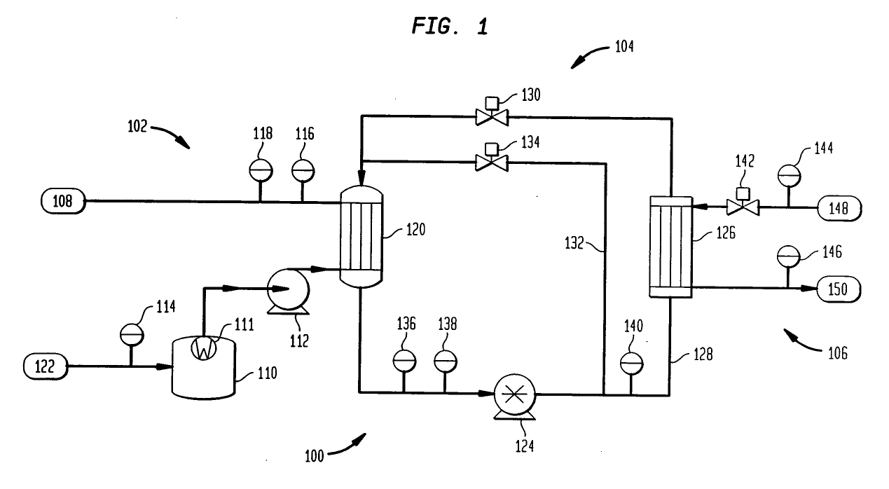

FIG. 1 is a schematic representation of an embodiment of a chiller 100 according to the present invention. The thermal compression cycle of the chiller 100 involves three loops: the coolant loop 102, the refrigerant loop 104, and the water cooling loop 106, the operation of which are controlled by a control system. The objective of the coolant loop 102 is to supply the coolant to the process 108 at a specific flow rate 118 and temperature 116. Typically, the coolant flow rate 118 is not directly controlled by the control system. Controlling the coolant supply temperature 116 is the objective of the control system and the primary focus in this invention.

The coolant loop 102 includes a coolant reservoir 110 having a coolant heater 111, a pump 112, the warm side of the evaporator 120 and several tapping points with sensors 114, 116 and 118 for measuring the coolant return temperature (T_{cr}), the coolant supply temperature (T_{cs}) and the coolant flow rate (F_{c}), respectively. The coolant loop 102 supplies a coolant, for example, a non-conductive perfluorocarbon, to a semiconductor process 108 and the loop 102 passes through the warm side of the evaporator 120 to remove heat gained from the semiconductor process 108. The coolant loop 102 may be used to control the temperature of a component or fluid within the process 108. For example, the coolant loop 102 may pass through a semiconductor tool to maintain or adjust the temperature of an electrostatic chuck, quartz window or chamber wall. The coolant loop 102 is a closed loop and the coolant flows continuously from the warm side of the evaporator 120 to the process 108, returns from the process 122, and flows through the reservoir 110, heater 111, circulation pump 112, and back to the warm side of the evaporator 120.

The refrigerant loop 104 operates to remove heat from the coolant and to control the rate of heat removal from the coolant. In addition to the evaporator 120, the refrigerant loop 104 includes a compressor 124, a condenser 126, a main refrigerant line 128 having an adjustable refrigerant valve 130 and an adjustable hot gas bypass line 132 having a hot gas bypass valve 134. The refrigerant loop 104 may also include tapping points having sensors 136, 138 and 140 to measure the evaporation temperature (Tᵣₑ), the evaporation pressure (Pᵣₑ) and the condensation pressure (P_{rc}), respectively. The sensors 136, 138 and 140 are primarily used to ensure that the compressor 124 is operating under suitable conditions. Like the coolant loop 102, the refrigerant loop is also a closed loop wherein the refrigerant flows continuously through the compressor 124, the warm side of the condenser 126, the liquid expansion valve 130, and the cold side of the evaporator 120. The refrigerant exits the cold side of the evaporator 120 as a vapor. The vapor is then compressed and either flows through the hot gas bypass line 132 to the evaporator 120 as compressed hot gas or flows through the condenser 126 where the water cooling loop 106 removes heat from the compressed hot gas which condenses and returns to the evaporator 120.

The cooling water loop 106 operates to remove heat from the refrigerant as it passes through the condenser 126. In addition to the condenser 126, the cooling water loop includes an adjustable cooling water control valve 142, a cooling water supply 148, a cooling water return 150 and tapping points having sensors 144 and 146 for measuring the cooling water supply temperature (T_{cws}) and the cooling water return temperature (T_{cwr}), respectively. During operation, cooling water recycles through the cooling water control valve 142 and the cold side of the compressor 126 to remove heat from the refrigerant.

In a typical thermal compression cycle, the refrigerant vapor exiting the evaporator 120 at a first lower evaporation pressure 138 and temperature 136 flows through the compressor 124 and reaches the higher condensation pressure 140. The hot vapor is then condensed in the condenser 126 where condensation heat is dissipated by the cooling water loop 106. The condensed refrigerant exits the warm side of the condenser 126 and enters the cold side of the evaporator 120 where it adsorbs heat from the return coolant 122 and evaporates, once again, at the temperature corresponding to evaporation pressure 138. Depending upon the coolant return temperature 114, the amount of refrigerant needed to cool the coolant is controlled by the liquid expansion valve 130 and the hot gas bypass valve 134.

The method of the invention includes feedback and feed-forward control methodologies to maintain the coolant supply temperature 116 at a user-defined setpoint and to provide a fast response in adjusting the temperature when heat loading and unloading occurs from the process 108. The objective of the feedback aspect of the control system is to maintain a constant coolant supply temperature 116 which is controlled by constantly adjusting the liquid expansion valve 130 and the hot gas bypass valve 134. When the liquid expansion valve 130 opens more (i.e. the orifice size increases), additional refrigerant flows through the cold side of the evaporator 120, thus, more heat is removed from the coolant. As a result, the coolant supply temperature 116 decreases. In contrast, when the hot gas bypass valve 134 opens more, additional hot gas flows through the cold side of the evaporator 120 and the evaporator's 120 cooling capacity is thereby reduced so that less heat is removed from the coolant. As a result, the coolant supply temperature 116 increases. The coolant supply temperature 116 is thus controlled by balancing the positions (i.e. the orifice sizes) of the liquid expansion valve 130 and the hot gas bypass valve 134. For example, if the coolant supply temperature 116 is higher than the user defined setpoint (Tₛₚ), the control system commands the liquid expansion valve 130 to open more and the hot gas bypass valve 134 to open less. Notably, the setpoint may be changed by the user at any time through a human-machine interface (HMI) or by some other electronic input.

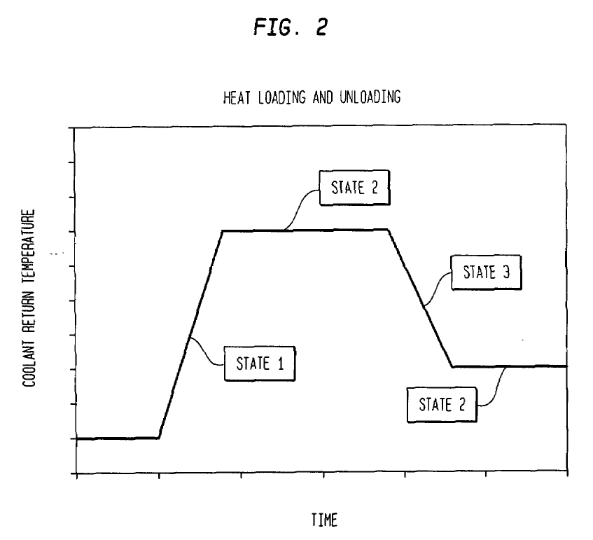

When a process involves a series of heat loading and unloading steps involving an unspecified amount of heat gain or loss, the control system uses the foregoing feedback control method in addition to a feed-forward methodology. FIG. 2 illustrates a typical heat change (i.e. heat loading and unloading) process where the coolant return temperature 114 is graphed as a function of time. The coolant supply temperature 116 is not a good indicator of heat loading and unloading because it is controlled at a user defined setpoint. The heat change process illustrated in FIG. 2 can be described by three states: State 1, State 2, and State 3. During State 1, the coolant return temperature 114 increases at a certain rate (i.e. the slope of the line for State 1) as the coolant experiences heat loading from the process 108. State 1 thus represents a condition where the temperature 114 increases as a function of time. While the heat loading continues, the coolant return temperature 114 will eventually reach a steady state value which marks the beginning of State 2. State 2 thus represents a steady state condition for the coolant return temperature 114. State 3 illustrates the process for when the applied heat is unloading and the coolant return temperature 114 decreases at a certain rate (i.e. the slope of the line for State 3). State 3 represents a condition where the temperature 114 is decreasing as a function of time. State 3 terminates when the heat unloading process reaches a new steady state temperature and State 2 begins again. FIG. 2 simply provides an illustration of a heat loading and unloading process. Notably, the heat loading and unloading sequence may vary depending upon the requirements of the process 108 or the user. For example, the process 108 may apply additional heat loading at the end of State 2 so that State 1 begins again.

The present invention further includes a novel method for early detection of changes in the heat load. Depending on the heat loading rate, the control system employs various techniques to manipulate the control variables and achieve a constant coolant return temperature 114.

Prior art temperature control systems typically use passive feedback control whereby the refrigerant flow is regulated in response to the error between the coolant supply temperature and the coolant temperature setpoint. However, because there is a time delay (i.e. a lag) between an actual increase in the coolant temperature resulting from heat loading or unloading (occurs upstream of the evaporator) and the measured coolant supply temperature (measured downstream from the evaporator), the error between the coolant supply temperature and the temperature setpoint, is only detected when the system begins to loose control of the coolant supply temperature. Hence, the control system causes large overshooting or undershooting of the coolant supply temperatures. The present invention overcomes this problem by quickly and accurately detecting the heat loading and unloading states (i.e. State 1 and State 3), and responding to these changes by adjusting the refrigerant temperature and flow rate to meet the process demand 108 before loss of control occurs.

To detect the heat loading and unloading states, the control system of the present invention continuously monitors a source temperature signal whether it is rising, falling, or holding steady. The source temperature signal may be the coolant return temperature 114, the difference between the coolant return temperature 114 and the coolant supply temperature 116, or the rate of change of either of these signals. For the method to be effective and accurate, the measurement uncertainty or noise must be removed from the source signal.

To filter out the measurement uncertainty or noise in the source signal, the method of the present invention uses an exponentially weighted moving average (EWMA). For a signal, S, its EWMA at time t is defined by applying the following equation recursively over time:

S̅ₜ̅=wSₜ_{₀}+(1−w)Sₜ Equation 1

where to is the time when the signal, S, is previously scanned and w is a weighing factor or filter constant between 0 and 1 (inclusive).

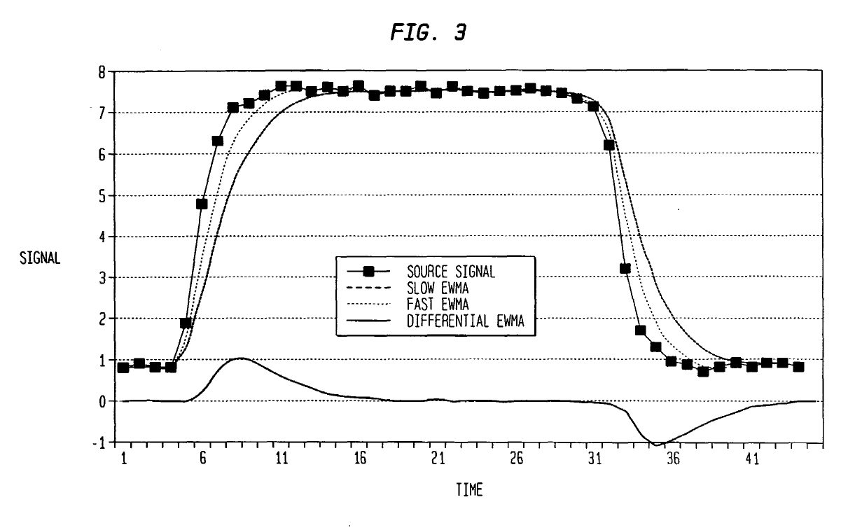

The EWMA depends strongly on the filter constant (i.e. the weighing factor w). FIG. 3 illustrates two EWMAs with two filter constants, a slow following EWMA (SEWMA) corresponding to a larger filter and a fast following EWMA (FEWMA) corresponding to a smaller filter (for illustration purposes, the gaps between the lines may have been exaggerated). The FEWMA line is closer to the original signal than the SEWMA line. When the source signal increases (e.g. the coolant return temperature 114 increases due to heat loading), the fast and slow EWMA lines begin to diverge and the fast EWMA line is above the slow EWMA line. Conversely, when the source signal decreases (e.g. the coolant return temperature 114 decreases due to heat unloading), the fast and slow EWMA lines begin to diverge but the FEWMA line is below the SEWMA line. When the source signal reaches a steady state value, the fast and slow moving EWMA lines begin to converge.

Note that when the filter constant w for the fast EWMA is set to 0, the fast EWMA becomes the source signal itself. The heat load or unload can thus be detected by using only the SEWMA and the signal itself. The heat change can be also detected by determining the slope (i.e. the rate of change) of the individual EWMAs. For example, when the slope is positive, heat is being loaded. The slope of the EWMA also indicates how fast the signal is changing.

While the EWMA is the preferable method for filtering the source signal, one of ordinary skill in the art will appreciate that there are other ways to filter the source signal and detect moving trends. For example, a Simple Moving Average in which the average is calculated from a fixed number of the recent measurements may be used or a Weighted Moving Average where the recent measurements are weighted linearly according to their “age” may also be used to filter the source signal. Thus, by applying appropriate filters to appropriate source signals, meaningful changes in heat loading or unloading can be detected.

FIG. 3 also illustrates the differential EWMA (DEWMA), shown in the lower part of the figure, which is calculated by subtracting the slow EWMA from the fast EWMA. The differential EWMA can indicate how fast the source signal is changing or, as used in the invention, the strength of the heat load. The differential EWMA can be related to heat change states. When the DEWMA is positive, it indicates State 1. When DEWMA is negative, it indicates State 3 and State 2 corresponds to the DEWMA fluctuating around zero.

The following example illustrates how the DEWMA may be used by the control system. If the rate of change between the coolant return temperature 114 and the coolant supply temperature 116 is used as the raw source signal and both the fast and slow moving EWMAs are used, some positive parameters, x₁ and x₂ (0<x₂<x₁) can be applied to detect the heat change states. Assume x₁=0.5 and x₂=0.2; Table 1 illustrates some rules that can be used to decide which heat change state the process is in.

TABLE 1
Logic rules used to determine heat change states

| Heat | | |
|---|---|---|
| change | Description | Rules for Deciding States |
| State-1 | Increasing heat load | If DEWMA > 0.5 |
| State-2 | Maintaining heat load | If −0.2 < DEWMA < 0.2 |
| State-3 | Decreasing heat load | If DEWMA < −0.5 |

The following formula (Equation 2) has been found to work very well in determining the above three states:

x₁=a₁×max(1,e^{a}^{₃}^{T}^{ₛₚ}),

x₂=a₂×max(1,e^{a}^{₄}^{T}^{ₛₚ}), Equation 2

where a₁ through a₄ are constants and Tₛₚ is the temperature setpoint.

According to the rules and example shown in Table 1, the heat change state is undetermined if the DEWMA is between 0.2 and 0.5 or between −0.5 and −0.2. If the DEWMA=0.3, human judgment would consider the signal “more likely” in State 2 than in State 1; if the DEWMA=0.4, human judgment would consider the signal “more likely” in State 1 than in State 2, and so on. Thus, the method would fail if a determination could only be made of the states that are “likely” to be correct, because selecting which output function to use would be impossible. Fuzzy logic can be used to solve this problem.

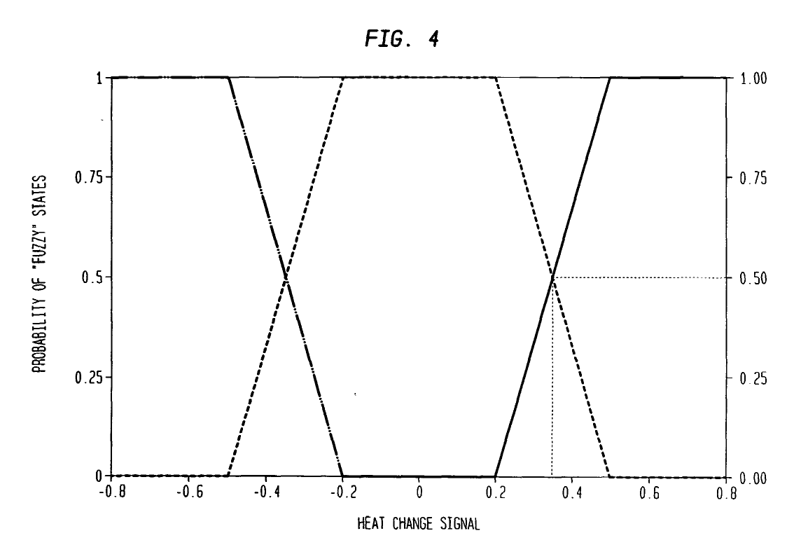

Fuzzy logic treats uncertainty or probability between two states as a number between 0 and 1, rather than being simply “one” state or “the other”. Thus, if the DEWMA=0.35, a simple fuzzy rule may yield that the “state” is in State 1 with 50% probability and in State 2 with 50% probability. This process of transferring the crisp DEWMA value to “fuzzy” heat change states is fuzzification. This fuzzification process is illustrated in FIG. 4. In FIG. 4, the area under the solid line covers State 1, that under dashed line covers State 2, and that under the dash-dotted line covers State 3. Note that State 2 overlaps both States 1 and 3 in the ranges of the DEWMA between −0.5 to −0.2 and 0.2 to 0.5, respectively. When the DEWMA falls into these two overlapped ranges, the state cannot be decided deterministically so fuzzification rules must be applied. The dotted lines in FIG. 4 illustrate graphically how the above probability of 50% is determined for the DEWMA=0.35.

The above probability values also enable calculation of the control output. The control output can be calculated for each state involved (i.e. State 1 and 2 in the above example). The final total control output is then calculated as 50% of the output from State 1 and 50% of that from State 2.

The above example illustrates fuzzification using simple linear interpolation. That is, the fuzzy or uncertain state is determined by a linear interpolation (along the straight lines in FIG. 4) and the final output is obtained by linear summation. In another embodiment of the present invention, a non-linear transform function as shown in Equation 3 can be used for interpolation.

R=tan h(r₀+r₁d+r₂d²)×r₃+r₄ Equation 3

where lower case letters denote constants and d denotes the DEWMA.

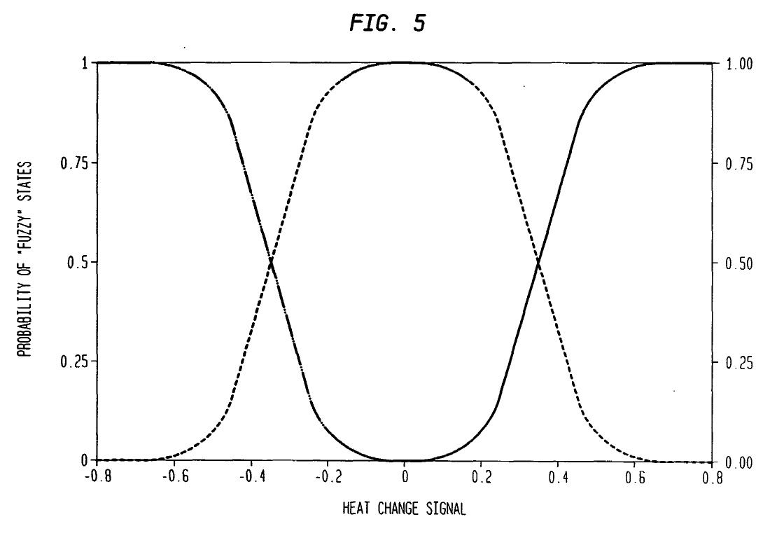

FIG. 5 is a graphical representation of this non-linear transform function. FIG. 2 is similar to FIG. 4 except for smoothed corners. Note that the shape of curves in FIG. 5 can be modified by applying different constants. Thus, this non-linear transform function is more flexible and offers smooth continuity in the control output as compared to the linear function illustrated in FIG. 4. Notably, in the example given in FIG. 4, the heat load is characterized into three states and the detecting variable, the DEWMA, is divided into five regions, each state being assigned to one region with the remaining two regions linked to the states through fuzzification. In FIG. 5, however, the three states are assigned with a point value, rather than a region of the DEWMA values. States 1, 2, and 3 are assigned +∞, 0, and −∞, respectively. All other values of DEWMA are assigned to the three states through fuzzification via continuous functions of the type illustrated in Equation 3.

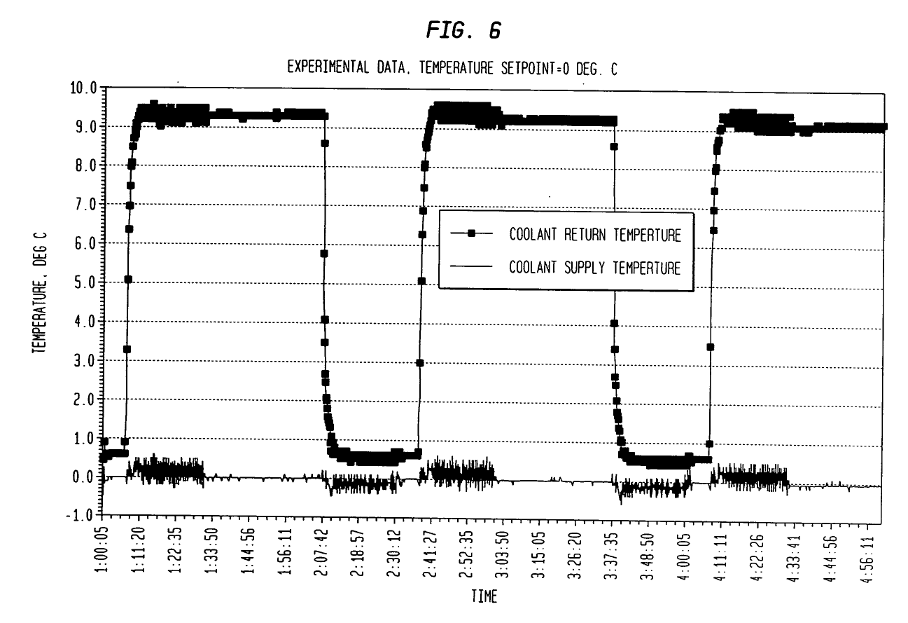

FIG. 6 provides experimental data for a chiller controlled at 0° C. with periodic head loading and unloading. In this experiment, the coolant flow rate was fixed; the hot gas bypass valve 134, liquid expansion valve 130 and the cooling water valve 142 were separately controlled by three standard PID controllers. The temperature was controlled to less than 1° C. during heat change and less than 0.5° C. after reaching steady state.

In summary, the invention is directed to a temperature control system, wherein the heat load is characterized into a set of states based on the value of a process variable and according to a set of logic rules. For each state and for each controlled variable, there is a control algorithm tuned to predict the control output of that variable for that state.

During operation, the process variable is used to detect the state of heat load and provide feed forward control outputs for one or more controlled variables. The process variable may be a measured variable, or the rate of change of a measured variable, or is a derived variable calculated or transformed from one or more measured variables. The measured variable may be the coolant return-temperature. The derived variable may be the difference between the coolant return-temperature and the coolant supply-temperature or the rate of change of the difference. The derived variable may also be the difference between the coolant return-temperature and the temperature setpoint or the rate of change of the difference. In addition, the derived variable may be a Simple Moving Average of the process variable or a Weighted Moving Average of the process variable. The derived variable may also be an Exponentially Weighted Moving Average of the process variable or the difference between two Exponentially Weighted Moving Averages of the process variable with two different weighing factors. When the averages are evaluated at a frequency of about 5 to 50, one of the weighing factors may be between 0.7 and 0.95 while the other weighing factor has a greater value.

The derived variable may be predicted from the process variable using a computational forecasting technique or a numerical modeling method. The set of states may include three states: increasing heat load, decreasing heat load, and maintaining heat load. The entire range of the values of the process variable is divided into at least three continuous regions. Each state is assigned with a region so that when the value of the process variable falls into that region it can be asserted, for the purpose of temperature control, that the system is in that state with sufficiently high confidence. Unassigned regions, if there are any, are linked to the three states through fuzzification. The control output of a controlled variable is obtained by applying defuzzification rules on the outputs for that controlled variable and for all states involved in fuzzification. The three continuous regions may be divided into five continuous regions. A first, second, and third region being determined, respectively, such that the state of increasing, decreasing, or maintaining heat load can be determined with sufficiently high confidence when the value of the process variable falls into the first region. The forth and fifth region are between the first and second regions and between the second and third region, respectively.

The present invention as described above and shown provides an accurate and responsive method for controlling the temperature of a process or controlling the components or flow of fluids within the process. It is anticipated that other embodiments and variations of the present invention will become readily apparent to the skilled artisan in light of the foregoing description and examples, and it is intended that such embodiments and variations likewise be included within the scope of the invention as set forth in the following claims.

I/We claim:

1. A method for controlling temperature of a process comprising the steps of:
supplying a coolant from an evaporator to the process;
measuring temperature of the coolant supplied to the process;
determining the difference between the coolant supply temperature and a coolant supply temperature setpoint;
removing heat from the coolant by flowing a refrigerant through the evaporator;
measuring temperature of the coolant returning from the process;
calculating a differential exponentially weighted moving average (DEWMA) from the measured coolant supply temperature and the measured coolant return temperature;
determining a heat change state by comparing the DEWMA to predetermined logic rules;
predicting the temperature of the coolant returning from the process based upon the heat change state; and
adjusting flow rate of the refrigerant based upon the predicted temperature.

2. The method of claim 1 wherein the step of determining the heat change state comprises applying fuzzy logic and fuzzification rules.

3. The method of claim 1 wherein the step of adjusting the flow rate of the refrigerant comprises controlling a liquid expansion valve.

4. The method of claim 3 comprising the step of removing heat from the refrigerant by flowing the refrigerant through a condenser.

5. The method of claim 4 comprising the step of flowing a portion of the refrigerant through a hot gas bypass line upstream from the condenser and into the evaporator.

6. The method of claim 5 comprising the step of adjusting the flow rate of the refrigerant in the hot gas bypass line by controlling a hot gas bypass valve.

7. The method of claim 1 wherein the step of determining the heat change state comprises comparing the DEWMA to predetermined logic rules comprising:
State 1, if DEWMA>0.5;
State 2, if −0.2<DEWMA<0.2; and
State 3, if DEWMA<−0.5.

8. The method of claim 7 wherein the step of determining the heat change state comprises applying fuzzy logic and fuzzification rules.

9. The method of claim 1 wherein the process is a semiconductor process.

10. A method for controlling temperature of a component in a semiconductor process tool comprising the steps of:
supplying a coolant from an evaporator to the component;
measuring temperature of the coolant supplied to the component
determining the difference between the coolant supply temperature and a coolant supply temperature setpoint;
removing heat from the coolant by flowing a refrigerant through the evaporator;
measuring temperature of the coolant returning from the component;
filtering the measured coolant return temperature data to remove uncertainty and noise;
determining a heat change state by comparing the filtered coolant return temperature data to predetermined logic rules;
predicting temperature of the coolant returning from the component based upon the heat change state; and
adjusting flow rate of the refrigerant based upon the predicted temperature.

11. The method of claim 10 wherein the step of determining the heat change state comprises applying fuzzy logic and fuzzification rules.

12. The method of claim 10 wherein the step of adjusting the flow rate of the refrigerant comprises controlling a liquid expansion valve.

13. The method of claim 12 comprising the step of removing heat from the refrigerant by flowing the refrigerant through a condenser.

14. The method of claim 13 comprising the step of flowing a portion of the refrigerant through a hot gas bypass line upstream from the condenser and into the evaporator.

15. The method of claim 14 comprising the step of adjusting the flow rate of the refrigerant in the hot gas bypass line by controlling a hot gas bypass valve.

16. The method of claim 10 wherein the step of determining the heat change state comprises comparing the DEWMA to predetermined logic rules comprising:
State 1, if DEWMA>0.5;
State 2, if −0.2<DEWMA<0.2; and
State 3, if DEWMA<−0.5.

17. The method of claim 16 wherein the step of determining the heat change state comprises applying fuzzy logic and fuzzification rules.

18. The method of claim 10 wherein the component is selected from the group consisting of an electrostatic chuck, a quartz windows and a chamber wall.

19. The method of claim 10 wherein the step of filtering the measured coolant return temperature data to remove uncertainty and noise comprises calculating the difference between a slow moving exponentially weighted moving average and a fast moving exponentially weighted moving averaged to determine a differential exponentially weighted moving average.

20. The method of claim 10 wherein the step of filtering the measured coolant return temperature data to remove uncertainty and noise comprises calculating a simple moving average.

21. The method of claim 10 wherein the step of filtering the measured coolant return temperature data to remove uncertainty and noise comprises calculating a weighted moving average.
